(19) United States
(12) Patent Application Publication
(10) Pub. No.: US 2025/0353050 A1
(43) Pub. Date: Nov. 20, 2025

(54) WASHING MACHINE FOR WASHING EMPTY CONTAINERS ADAPTED TO BE FILLED WITH A POURABLE PRODUCT

(71) Applicant: SIDEL PARTICIPATIONS, OCTEVILLE-SURMER (FR)

(72) Inventor: Andrea SOLFA, PARME (IT)

(21) Appl. No.: 18/869,676

(22) PCT Filed: May 26, 2023
(86) PCT No.: PCT/EP23/64271

§ 371 Date: Nov. 26, 2024

(30) Foreign Application Priority Data
May 30, 2022 (EP) 22176062.2

(51) Int. Cl. B08B 9/24; B08B 9/08

(52) U.S. Cl. CPC B08B 9/24; B08B 9/083

(57) ABSTRACT

There is described a washing machine configured to wash empty containers adapted to be filled with a pourable product, the washing machine includes: a conveyor device configured to convey a plurality of containers along a washing path in an advancement direction; at least one tank for holding a cleaning medium, the washing path extending within and along the tank; and a hollow passage which extends through the tank and which is fluidly isolated from the tank. The washing machine further includes a pair of extraction devices arranged in fluid communication with the tank, fluidly isolated from the hollow passage, and configured for detaching/removing labels from the containers advanced in the tank and for receiving the detached/removed labels, thereby extracting such labels from the tank.

### TECHNICAL FIELD

The present invention relates to a washing machine for washing (and cleaning) empty containers adapted to be filled with a pourable product, preferably a pourable food product.

### BACKGROUND ART

Washing machines are known which are configured for washing and cleaning containers (usually used containers which have been emptied from the pourable product they are adapted to contain) upstream of a filling machine and a labelling machine, in which the containers are respectively filled with the pourable product and labelled with respective labels.

An example of washing machine is known, e.g. from EP-A-2727660 in the name of the same Applicant.

A typical washing machine of the above type essentially comprises:
a washing tunnel;
a looped chain conveyor advancing the containers along a closed washing path which extends inside the washing tunnel from an inlet station to an outlet station;
a feeding system for feeding containers to be treated to the chain conveyor; and
a plurality of consecutive treatment zones arranged between the inlet station and the outlet station, crossed by the washing path, and through which the chain conveyor advances the containers.

In detail, the chain conveyor comprises a plurality of beams, which are fed at the inlet station by the feeding system with respective rows of containers.

In greater detail, each beam comprises a plurality of aligned pockets organized in respective rows, each pocket being configured to receive one container to be treated at a time, to convey such container from the inlet station to the outlet station through the washing tunnel and along the washing path, and to deliver the respective washed container at the outlet station.

More precisely, each beam is discharged of the respective washed containers at the outlet station and then is returned along a return path to the inlet station, where it receives new empty containers to be washed.

According to the advancing direction of the containers along the washing path and inside the washing tunnel, the treatment zones comprise, in sequence: a prewash zone, at least first and second cleaning zones, and a plurality of consecutive rinsing zones.

The prewash zone, the first cleaning zone, and the second cleaning zone comprise respective cleaning baths, defined by respective tanks which are filled with washing chemical agents and through which the containers are advanced.

Each rinsing zone comprises several rinsing baths filled with rinsing liquid and/or ejecting devices for directing sprinkles of rinsing liquid toward the containers.

In general, the containers need to be treated through the cleaning zones for a relatively long time and at relatively high temperatures in order to be effectively deprived from the most encrusted dirt mounds, especially the ones heavily sedimented at the bottom of the containers themselves.

This can lead to high energy consumption or to a longer cleaning time.

The use of ultrasonic waves has been proposed, such as in WO-A-2020119958 in the name of the same Applicant, for aiding the cleaning process, in order to reduce energy consumption and/or cleaning time.

Briefly, the ultrasonic waves propagate in water and, more in general, in a medium with a relative periodic motion with respect to the medium itself, such that local micro-zones within the medium pass periodically from a depressurized to a pressurized state.

During the depressurized state, air dissolved within the medium tends to form many microbubbles, which implode when pressure increases so as to release energy.

Such energy may be useful to disaggregate the aforementioned encrusted dirt mounds, such that cleaning the containers results significantly eased, thus requiring less energy and/or less time.

The need for extracting labels from the tanks during the aforementioned cleaning operation is known in the field.

To this end, WO-A-2020119958 discloses suction apparatuses, each arranged at the bottom of the tank defining the relative cleaning bath.

In particular, each suction apparatus is configured to suck the labels which are detached from the containers during the cleaning bath in the first or second cleaning zone and which precipitate to the bottom of the tank due to gravity and due to the pushing action exerted by the chain conveyor.

Although the known washing machines are functionally valid, the Applicant has observed that they are still open to further improvement, in particular as per the efficacy of the removal of labels from the containers during cleaning thereof.

### DISCLOSURE OF INVENTION

It is therefore an object of the present invention to provide a washing machine which is designed to meet the above-mentioned need in a straightforward and low-cost manner.

This object is achieved by a washing machine as claimed in claim 1.

### BRIEF DESCRIPTION OF THE DRAWINGS

A non-limiting embodiment of the present invention will be described by way of example with reference to the accompanying drawings, in which:

FIG. 1 is a schematic lateral view, partially sectioned, and with parts removed for clarity of a washing machine according to the invention; and

FIG. 2 is a larger-scale lateral view of portion of the washing machine of FIG. 1.

### BEST MODE FOR CARRYING OUT THE INVENTION

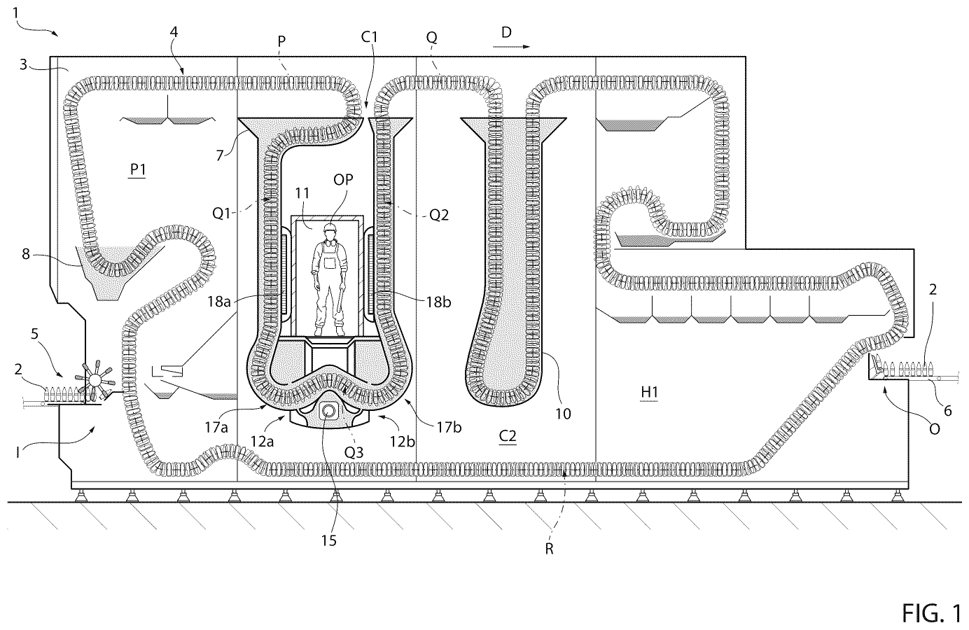

With reference to FIG. 1, number 1 indicates as a whole a washing machine configured to wash empty containers 2 adapted to be filled with a pourable product, preferably a pourable food product, such as beer, wine, water, juice, soft drinks, milk or the like.

In particular, containers 2 are defined by respective empty bottles (for example, returnable glass bottles) intended to be filled with the pourable product.

Washing machine 1 comprises:
a washing tunnel 3 into which empty containers 2 are fed and accordingly washed; and
a conveyor device 4 configured to convey a plurality of containers 2 along a washing path P in an advancement direction.

Preferably, the conveyor device comprises a chain conveyor 4 for advancing containers 2 along a closed-loop washing path P inside washing tunnel 3, so as to convey containers 2 from one end of the tunnel 3 to the other end along a general direction D, preferably horizontal with respect to gravity.

In detail, chain conveyor 4 is of the type described in WO-A-2020119958 and comprises:
a pair of chains (not shown) elongated parallel to path P and parallel to one another; and
a plurality of subsequent conveying beams (not shown), which extend between the chains in a transversal and, more in detail, orthogonal manner to the chains and path P.

Specifically, each beam comprises a row of pockets (not shown) aligned orthogonally to path P and configured to receive corresponding containers 2.

In such a manner, containers 2 carried by a corresponding beam are aligned orthogonally to path P and housed inside the respective pockets, individually.

Washing machine 1 comprises also a feeding system 5 of the known type (only schematically shown in FIG. 1) for feeding a sequence of empty containers 2 along direction D and at an inlet station I of washing tunnel 3. Expediently, containers 2 are fed by feeding system 5 along direction D arranged in rows orthogonal to path P.

In use, the most forward containers 2 of each row of containers 2 are transferred by feeding system 5 to the respective pockets of the beam that is travelling at inlet station I.

Washing machine 1 further comprises an outfeed conveyor 6, which receives rows of cleaned containers 2 from chain conveyor 4 at an outlet station O of washing tunnel 3.

In view of the above, path P comprises:
a washing branch Q, which extends from inlet station I to outlet station O and along which containers 2 are advanced by chain conveyor 4; and
a return branch R, which extends from outlet station O to inlet station I and defines a return zone through which the beams return towards inlet station I after having discharged containers 2.

According to the aforementioned advancing direction of the containers 2 along path P, washing machine 1 comprises in sequence along washing branch Q:
a prewash zone P1;
a first cleaning zone C1;
preferably, a second cleaning zone C2; and
a final rinsing zone H1.

In the present disclosure, for the sake of clarity, terms like “upstream of” and “downstream of” are to be intended throughout the whole description and claims with reference to the advancing direction of the containers 2 along path P.

The operation of washing machine 1 at the prewash zone P1, second cleaning zone C2 and final rinsing zone H1 is well-known, for example from WO-A-2020119958, and therefore will not be described in detail herein.

Reference will be made in the following to first cleaning zone C1.

Within first cleaning zone C1, washing machine 1 comprises a respective tank 7 for a holding corresponding cleaning medium or agent.

In detail, tank 7 is filled with a cleaning agent which, in use, is brought to a temperature higher than that within the prewash zone P1, for instance between 65° C. and 80° C., so that dirt on advancing containers 2 is fully removed.

In greater detail, path P, and particularly a portion of washing branch Q, extends within and along tank 7.

Hence, tank 7 defines a cleaning (hot) bath of washing machine 1 for cleaning the containers 2.

Preferably, the prewash zone P1 and the second cleaning zone C2 comprise respective tanks 8, 10 which are filled with cleaning agents at different respective temperatures (according to a manner known and not described herein), thus defining respective further cleaning baths of washing machine 1.

Conveniently, the cleaning agents filling the respective tanks 7, 8, 10 comprise corresponding basic aqueous solutions that include, in particular, sodium hydroxide.

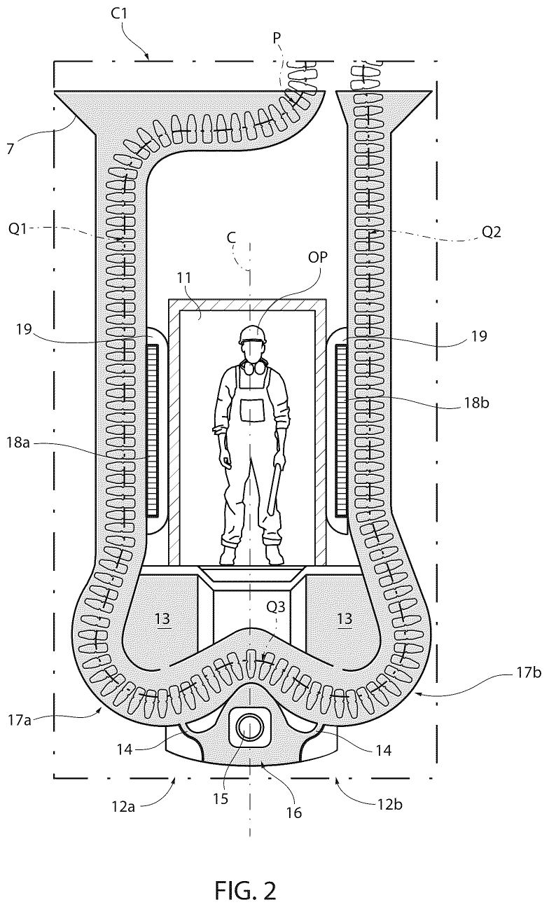

As visible in FIG. 1 and, more in detail in FIG. 2, washing machine 1 comprises a hollow passage 11 which extends through tank 7 and which is fluidly isolated from tank 7.

In particular, path P, and particularly washing branch Q, has, within tank 7, an inlet sector Q1 for advancing containers 2 in tank 7 and an outlet sector Q2 for advancing containers 2 out from tank 7.

Conveniently, hollow passage 11 extends through tank 7 in such a way to be interposed between inlet sector Q1 and outlet sector Q2.

Expediently, hollow passage 11 defines a tunnel (e.g. an inspection and/or maintenance tunnel) accessible by a maintenance operator OP from the outside of washing machine 1.

More specifically, hollow passage 11 has a size such that the operator OP, i.e. a normal-sized person, can fit and perform inspection and/or maintenance operation therein.

Thanks to the presence of hollow passage 11, inspection and/or maintenance of the components located at tank 7 and in the vicinity of tank 7 is facilitated and improved.

According to the preferred embodiment shown, hollow passage 11 is blind, i.e. its entrance corresponds with its exit.

Consequently, the inspection and/or maintenance tunnel defined by hollow passage 11 is a blind tunnel or blind hole, and not a through tunnel or through hole.

Alternatively, hollow passage 11 is defined by a through hole, i.e. it extends through tank 7 from side to side.

Advantageously, washing machine 1 further comprises a pair of extraction devices 12a, 12b arranged in fluid communication with tank 7, fluidly isolated from hollow passage 11, and configured for detaching/removing labels (not shown) from the containers 2 advanced, in use, in tank 7 and for receiving the detached/removed labels, thereby extracting such labels from tank 7 (and from washing machine 1).

In particular, the pair of extraction devices comprises: a first extraction device 12a arranged downstream of inlet sector Q1, and a second extraction device 12b arranged downstream of first extraction device 12a and upstream of outlet sector Q2, relative to said advancement direction along path P.

As visible in detail in FIG. 2, tank 7 has an open-loop cross-section with a substantially U-shaped profile around hollow passage 11.

In detail, inlet sector Q1 and outlet sector Q2 extend respectively along the two free arms of the U-shaped profile.

In greater detail, path P has, within tank 7, an extraction sector Q3 connecting inlet sector Q1 and outlet sector Q2 to one another and extending along a bottom section of the U-shaped profile arranged between the two free arms, i.e. at the bottom section of the tank 7.

Conveniently, the extraction devices 12a, 12b are arranged at extraction sector Q3.

This configuration is particularly advantageous, due to the fact that labels could be removed also before reaching first extraction device 12a, for example due to the high temperature of the cleaning agent within tank 7. Hence, by arranging extraction devices 12a, 12b at the bottom section of tank 7, the labels that have been pre-detached reach such bottom section due to gravity, and can be easily extracted thereat.

As visible in detail in FIG. 2, each extraction device 12a, 12b comprises:
an extraction duct 13 extending through tank 7, interposed between tank 7 and hollow passage 11, and configured to receive said detached/removed labels from tank 7 and to extract such detached/removed labels from washing machine 1; and
an inlet duct 14 configured to feed a removing fluid, preferably a high-pressure and/or high-speed removing fluid (such as water or cleaning medium) into tank 7 at extraction sector Q3 for detaching/removing the labels from the containers 2 advanced, in use, along extraction sector Q3 itself.

More specifically, each inlet duct 14 is associated with one respective extraction duct 13 and is arranged in a position opposite to such extraction duct 13 with respect to extraction sector Q3, for directing the removing fluid into such extraction duct 13 through tank 7.

More in particular, washing machine 1 comprises a pumping device 15 (only schematically shown in the Figures) for feeding the removing fluid into inlet ducts 14, preferably at high pressure and/or high speed.

In one embodiment, pumping device 15 is configured to recirculate the cleaning medium through inlet ducts 14 and within tank 7.

Conveniently, pumping device 15 is arranged at the aforementioned bottom section of the U-shaped profile, i.e. at the bottom part of tank 7, and in particular in a housing 16 adjacent (and below) to such bottom part of tank 7 and, therefore, to extraction sector Q3.

Hence, each inlet duct 14 is configured to convey the removing fluid from pumping device 15 to the relative extraction duct 13 through tank 7 (an particularly through the bottom part thereof), so that the removing fluid cooperates in contact with the containers 2 to remove, in use, the labels and directs the removed labels towards the relative extraction duct 13.

In other words, containers 2 are advanced between the inlet duct 14 and the extraction duct 13 of each extraction device 12a, 12b, sequentially.

Thanks to this peculiar configuration of extraction devices 12a, 12b, the labels are actively removed by the action of the removing fluid fed through inlet ducts 14, and then extracted through extraction ducts 13, after being directed therein by the same action of the removing fluid. In this way, it is ensured that labels are fully removed from containers 2.

Advantageously, tank 7 is shaped such that the U-shaped profile includes two lobes 17a, 17b at the aforementioned bottom section, which lobes define respective curved opposite ends of the extraction sector Q3, as visible in particular in FIG. 2.

In other words, tank 7 has a profile which is substantially U-shaped, curved and lobed at the bottom.

Advantageously, each extraction duct 13 extends through one respective lobe 17a, 17b, so that each lobe 17a, 17b extends around, particularly partially surrounds, one respective extraction duct 13.

In light of the above, each inlet duct 14 is arranged in a position opposite to the extraction duct 13 associated with the inlet duct 14 itself with respect to one relative lobe 17a, 17b.

Thanks to the above configuration, first cleaning zone C1, and therefore washing machine 1:
ensures a longer cleaning bath of containers 2 within tank 7 with the same occupied space, thanks to the lobes 17a, 17b;
has a compact, slender and more simple architecture, since extraction ducts 13 extend through the lobes 17a, 17b, while leaving space to include hollow passage 11, thereby also ensuring, at the same time, easy inspection and maintenance.

In use, containers 2 advanced within and along tank 7 are first conveyed along inlet sector Q1, then along extraction sector Q3, at which labels thereof are removed and then extracted, and finally along outlet sector Q2, by which they leave tank 7.

Accordingly, hollow passage 11 has a quadrilateral shape, preferably substantially rectangular, and is surrounded by tank 7 at least at three sides thereof.

Conveniently, washing machine 1 comprises at least one ultrasonic wave generator 18a, 18b coupled to tank 7, arranged adjacent to path P extending therein, and configured to propagate ultrasonic waves through the cleaning medium such that containers 2 can receive an ultrasonic cleaning treatment during their advancement through tank 7.

In detail, generator 18a, 18b is of the type described in WO-A-2020119958 and comprises a plurality of ultrasonic transducers (not shown), which are conveniently plate-shaped, are configured to convert electric power into ultrasounds, and are sequentially arranged adjacent and parallel to each other along inlet sector Q1 and/or outlet sector Q2.

In greater detail, generator 18a, 18b includes:
a first generator member 18a arranged adjacent to inlet sector Q1 for propagating ultrasonic waves towards the containers 2 advanced thereon, in use; and
a second generator member 18b arranged adjacent to outlet sector Q2 for propagating ultrasonic waves towards the containers 2 advanced thereon, in use.

Ultrasonic transducers preferably emit ultrasonic waves having an action range of at least 350 mm and a frequency between 25 kHz and 28 kHz.

Preferably, washing machine 1 includes an electric power generator (not shown) for supplying generator 18a, 18b with electric energy and a control unit (not shown) for controlling the electric power generator.

Conveniently, generator 18a, 18b includes a maintainable portion accessible from hollow passage 11 such that operator OP is able to perform maintenance operations thereon.

More specifically, washing machine 1 preferably comprises a compartment 19 communicating, at least selectively, with hollow passage 11, the maintainable portion being housed within compartment 19 such that the operator OP is able to perform said maintenance operations on the maintainable portion by accessing compartment 19 from hollow passage 11, as schematically shown in FIG. 2.

Advantageously, tank 7 has a substantially symmetric configuration relative to a center plane C thereof, more specifically a center place C of the U-shaped profile, as visible in FIG. 2.

In particular, lobes 17a, 17b are arranged on opposite sides of center plane C in respective positions symmetric relative to the center plane C itself.

Center plane C is orthogonal to said direction D.

The Applicant has observed that such a construction ensures a more ergonomic configuration of hollow passage 11, thereby improving the working conditions of operator OP, for example during maintenance, since the components are arranged at substantially equal distances from hollow passage 11. Moreover, the architecture of washing machine 1 is more simple and compact.

The operation of washing machine 1 is briefly described in the following.

Feeding system 5 advances a plurality of rows of containers 2 to be washed towards washing tunnel 3 in a manner parallel to direction D.

The properly positioned containers 2 are arranged with their respective longitudinal axes orthogonal to path P.

The beams of chain conveyor 4 withdraw (or are fed with) respective rows of containers 2 at inlet station I, advance containers 2 inside washing tunnel 3 along the washing branch Q, discharge rows of cleaned containers 2 at outlet station O onto outfeed conveyor 6, and return along return branch R devoid from containers 2.

In detail, containers 2 of each row are first carried by the respective pockets through prewash zone P1, then through first cleaning zone C1, then through second cleaning zone C2 and then through rinsing zone H1.

The advantages of washing machine 1 according to the present invention will be clear from the foregoing description.

In particular, the presence of two extraction devices 12a, 12b in the particular arrangement described above ensures a thorough removal of labels from containers 2, while the presence of hollow passage 11 provides for an easy and straightforward inspection and/or maintenance.

The peculiar conformation of tank 7, i.e. substantially U-shaped and with the two lobes 17a, 17b, provides for a longer bathing time while occupying the same space within tunnel 3. Also, the peculiar position of extraction ducts 13, substantially surrounded or “incorporated” by the lobes 17a, 17b, provides for a slender and compact architecture.

Clearly, changes may be made to washing machine 1 as described herein without, however, departing from the scope of protection as defined in the accompanying claims.

1. A washing machine configured to wash empty containers adapted to be filled with a pourable product, the washing machine comprising:
a conveyor device configured to convey a plurality of containers along a washing path in an advancement direction;
at least one tank for holding a cleaning medium, the washing path extending within and along the tank; and
a hollow passage which extends through the tank and which is fluidly isolated from the tank;
wherein the washing machine further comprises a pair of extraction devices arranged in fluid communication with the tank, fluidly isolated from the hollow passage, and configured for removing labels from the containers advanced in the tank and for receiving the removed labels, thereby extracting such labels from the tank.

2. The washing machine as claimed in claim 1, wherein the washing path has, within the tank, an inlet sector for advancing the containers in the tank and an outlet sector for advancing the containers out from the tank, the hollow passage extending through the tank and interposed between the inlet sector and the outlet sector;
and wherein the pair of extraction devices comprises: a first extraction device arranged downstream of the inlet sector, and a second extraction device arranged downstream of the first extraction device and upstream of the outlet sector relative to said advancement direction along the washing path .

3. The washing machine as claimed in claim 2, wherein the tank has an open-loop cross-section with a substantially U-shaped profile around the hollow passage, the inlet sector and the outlet sector extending along two free arms of the U-shaped profile, the washing path having, within the tank, an extraction sector connecting the inlet sector and the outlet sector to one another and extending along a bottom section of the U-shaped profile arranged between the two free arms; and
wherein the extraction devices are arranged at the extraction sector.

4. The washing machine as claimed in claim 3, wherein the tank is shaped such that the U-shaped profile comprises two lobes at said bottom section which define respective curved opposite ends of the extraction sector outlet sector;
wherein each extraction device comprises an extraction duct extending through the tank, interposed between the tank and the hollow passage, and configured to receive said removed labels from the tank and to extract such detached/removed labels from the washing machine; and
wherein each extraction duct extends through one respective said lobe, so that each lobe extends around one respective extraction duct.

5. The washing machine as claimed in claim 4, wherein each extraction device further comprises an inlet duct configured to feed a removing fluid into the tank at the extraction sector for detaching/removing the labels from the containers advanced, in use, along the extraction sector; and
each inlet duct being associated with one respective extraction duct and being arranged in a position opposite to such extraction duct with respect to the extraction sector, for directing the removing fluid into the extraction duct through the tank.

6. The washing machine as claimed in claim 5, wherein each inlet duct is arranged in a position opposite to the extraction duct associated with the inlet duct itself with respect to one relative lobe.

7. The washing machine as claimed in claim 5, further comprising:
a pumping device for feeding the removing fluid into the inlet ducts,
each inlet duct being configured to convey the removing fluid from the pumping device to the respective extraction duct through the tank, so that the removing fluid cooperates in contact with the containers to remove, in use, the labels and directs the removed labels towards the extraction duct .

8. The washing machine as claimed in claim 3, wherein the hollow passage has a quadrilateral shape and is surrounded by the tank at least at three sides thereof.

9. The washing machine as claimed in claim 1, wherein the hollow passage defines a tunnel accessible by a maintenance operator from outside of the washing machine.

10. The machine as claimed in claim 1, and comprising at least one ultrasonic wave generator coupled to the tank, arranged adjacent to the washing path, and configured to propagate ultrasonic waves through said cleaning medium such that said containers can receive an ultrasonic cleaning treatment during their advancement through said tank.

11. The washing machine as claimed in claim 9, further comprising at least one ultrasonic wave generator, wherein the ultrasonic wave generator comprises a maintainable portion accessible from said tunnel such that said maintenance operator is able to perform maintenance operations thereon.

12. The washing machine as claimed in claim 2, further comprising at least one ultrasonic wave generator, wherein the ultrasonic wave generator comprises:
a first generator member arranged adjacent to the inlet sector for propagating ultrasonic waves towards the containers advanced thereon, in use; and
a second generator member arranged adjacent to the outlet sector for propagating ultrasonic waves towards the containers (2) advanced thereon, in use.

13. The washing machine as claimed in claim 11, further comprising:
a compartment communicating, at least selectively, with said tunnel,
wherein the maintainable portion is housed within said compartment such that the maintenance operator is able to perform said maintenance operations on the maintainable portion by accessing said compartment from the tunnel.

14. The washing machine as claimed in claim 3, wherein the tank has a substantially symmetric configuration relative to a center plane of said U-shaped profile.

15. The washing machine as claimed in claim 4, wherein the tank has a substantially symmetric configuration relative to a center plane of said U-shaped profile, wherein said lobes are arranged on opposite sides of said center plane in respective positions symmetric relative to the center plane itself.

16. The washing machine as claimed in claim 6, further comprising a pumping device for feeding the removing fluid into the inlet ducts,
each inlet duct being configured to convey the removing fluid from the pumping device to the respective extraction duct through the tank, so that the removing fluid cooperates in contact with the containers to remove, in use, the labels and directs the removed labels towards the extraction duct.

17. The washing machine as claimed in claim 10, wherein the hollow passage defines a tunnel accessible by a maintenance operator from outside of the washing machine, wherein the ultrasonic wave generator comprises a maintainable portion accessible from said tunnel such that a maintenance operator is able to perform maintenance operations thereon.

18. The washing machine as claimed in claim 10, wherein the ultrasonic wave generator comprises:
a first generator member arranged adjacent to an inlet sector for propagating ultrasonic waves towards the containers advanced thereon, in use; and
a second generator member arranged adjacent to an outlet sector for propagating ultrasonic waves towards the containers advanced thereon, in use.

19. The washing machine as claimed in claim 12, further comprising:
a compartment communicating, at least selectively, with a tunnel,
wherein a maintainable portion is housed within said compartment such that a maintenance operator is able to perform maintenance operations on the maintainable portion by accessing said compartment from the tunnel.

20. The washing machine as claimed in claim 14, wherein the tank is shaped such that the U-shaped profile comprises two lobes at said bottom section which define respective curved opposite ends of an extraction sector outlet sector wherein said lobes are arranged on opposite sides of said center plane in respective positions symmetric relative to the center plane itself.
